(19) United States
(12) Patent Application Publication
(10) Pub. No.: US 2009/0269243 A1
(43) Pub. Date: Oct. 29, 2009

(54) ELECTRICALLY CONTROLLED MICROFLUIDIC SYSTEM

(75) Inventor: Daniel Sobek, Portola Valley, CA (US)

Correspondence Address: LAW OFFICES OF MIKIO ISHIMARU, 333 W. EL CAMINO REAL, SUITE 330, SUNNYVALE, CA, 94087, US

(73) Assignee: ZYMERA, INC., Portola Valley, CA (US)

(21) Appl. No.: 11/816,414

(22) PCT Filed: Jan. 28, 2005
(86) PCT No.: PCT/US2006/004683

§ 371 Date: Aug. 15, 2007

Related U.S. Application Data
(60) Provisional application No. 60/648,242, filed on Jan. 28, 2005.

(51) Int. Cl. G01N 27/00; B01J 19/00; G01N 21/00

(52) U.S. Cl. 422/82.01; 422/68.1; 422/82.05

(57) ABSTRACT

An electrically controlled microfluidic system (1300) is provided including: providing a probe fluid (128) extending longitudinally; restricting a longitudinal movement of the probe fluid (128) by capillary effects; moving the probe fluid (128) longitudinally using an electric field, an electric field gradient, or a combination thereof; reacting a fluid under test (130) with the probe fluid (128) to start a reacting mixture; and measuring the reacting mixture over distance, time, or a combination thereof.

### CROSS-REFERENCE TO RELATED APPLICATION(S)

This application claims the benefit of U.S. Provisional Patent Application Ser. No. 60/648,242 filed Jan. 28, 2005, and the subject matter thereof is hereby incorporated herein by reference thereto.

### TECHNICAL FIELD

The present invention relates to the electrically controlled movement of fluids within micron to millimeter scale flow structures, and more particularly to a system for enzyme activity measurements.

### BACKGROUND ART

Chemical protocols often involve a number of processing steps including metering, mixing, transporting, division, and other manipulation of fluids. For example, fluids are often prepared in test tubes, metered out using pipettes, transported into different test tubes, and mixed with other fluids to promote one or more reactions. During such procedures, reagents, intermediates, and/or final reaction products may be monitored, measured, or sensed in analytical apparatus. Microfluidic processing generally involves such processing and monitoring using minute quantities of fluid. Microfluidic processing finds applications in vast fields of study and industry. For instance, diagnostic medicine, environmental testing, agriculture, chemical and biological warfare detection, space medicine, molecular biology, chemistry, biochemistry, food science, clinical studies, and pharmaceutical pursuits are among the areas utilizing microfluidic processes.

A current approach to fluidic and microfluidic processing utilizes a number of microfluidic channels that are configured with microvalves, pumps, connectors, mixers, and detectors. While devices using micro-scale implementations of these traditional approaches may exhibit at least a degree of utility, vast room for improvement remains. For instance, pumps and valves used in traditional fluidic transportation are mechanical. Mechanical devices, particularly when coupled to thin microchannels, may be prone to failure or blockage. In particular, thin channels may become narrowed or partially-blocked due to buildup of channel contamination, which, in turn, may lead to mechanical failure of associated devices. Current microfluidic devices also lack flexibility, for they rely upon a fixed pathway of microchannels.

Electrical properties of materials have been employed to perform a limited number of fluidic processing tasks. For example, dielectrophoresis trapping has been utilized to aid in the characterization and separation of particles, including biological cells. An example of such a device establishes dielectrophoretic collection rates and collection rate spectra for dielectrically polarizable particles in a suspension. Particle concentrations at a certain location downstream of an electrode structure are measured using a light source and a light detector, which measures the increased or decreased absorption or scattering of the light which, in turn, indicates an increase or decrease in the concentration of particles suspended in the fluid. Although useful for determining particle dielectrophoretic properties, such a system is limited in application. In particular, such a system does not allow for general fluidic processing involving various interactions, sometimes performed simultaneously, such as metering, mixing, fusing, transporting, division, and general manipulation of multiple reagents and reaction products.

Another example of using certain electrical properties for specific types of processing is electrophoresis which allows charged molecules to be moved through a medium that fills a trench in response to electric fields generated by electrodes. Although useful for tasks such as separation, room for improvement remains in that such devices are not well suited for performing a wide variety of fluidic processing interactions on a wide variety of different materials.

There are other examples of using dielectrophoresis for performing specific, limited fluidic processing tasks. One is a method for promoting reactions between particles suspended in fluid by applying two or more electrical fields of different frequencies to electrode arrays. While perhaps useful for facilitating certain interactions between many particles of different types, the method is not well suited for general fluidic processing. Another is a method for manipulation of chemical species by dielectrophoretic forces. Although useful for inducing certain chemical reactions, its flexibility is limited, and it does not allow for general, programmable fluidic processing.

A major difficulty with many existing enzyme activity systems is that they compute the reaction velocity using a single measurement in time. End-point detection will not yield a good measure of the reaction velocity in cases where it varies with time, such as in irreversible competition. In many cases, end-point detection protocols require quenching the enzymatic reaction with a highly basic reagent before performing a measurement.

Thus, a need still remains for a reliable electronically controlled microfluidic system for life science applications, such as enzyme analysis, that is capable of performing complex microfluidic functions using no moving parts and a minimum of external components. In view of the vast amount of efficacy and toxicology screening done in drug development, it is increasingly critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides an electrically controlled microfluidic system including: providing a probe fluid extending longitudinally; restricting a longitudinal movement of the probe fluid by capillary effects; moving the probe fluid longitudinally using an electric field, an electric field gradient, or a combination thereof; reacting a fluid under test with the probe fluid to start a reacting mixture; and measuring the reacting mixture over distance, time, or a combination thereof.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIG. 1 is an electrically controlled microfluidic system, in an embodiment of the present invention;

FIG. 2 is a schematic view of the reaction analyzer, of FIG. 1;

FIG. 3 is a cross-sectional view of the probe fluid capillary, of FIG. 1;

FIG. 4 is a cross-sectional view of the probe fluid capillary, of FIG. 1, in a deposition stage;

FIG. 5 is a cross-sectional view of the probe fluid capillary, of FIG. 1, in a chemical-mechanical planarization phase;

FIG. 6 is a cross-sectional view of the probe fluid capillary, of FIG. 1, in an etching phase;

FIG. 7 is a cross-sectional view of the probe fluid capillary, of FIG. 1, in a cover phase;

FIG. 8 is a simulation series of a microfluidic element, in an embodiment of the present invention;

FIG. 9 is a simulation series of a mixing valve element, in an embodiment of the present invention;

FIG. 10 is a top view of a bi-directional sample inlet, in an embodiment of the present invention;

FIG. 11 is a 3-D solid model of the bi-directional sample inlet, of FIG. 10;

FIG. 12 is a schematic view of the bi-directional sample inlet, in an embodiment of the present invention; and

FIG. 13 is a flow chart of a system for an electrically controlled microfluidic system in an embodiment of the present invention.

### BEST MODE FOR CARRYING OUT THE INVENTION

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus are semi-diagrammatic and not to scale and, particularly, some of the dimensions are for the clarity of presentation and are shown greatly exaggerated in the drawing FIGs. Similarly, although the sectional views in the drawings for ease of description show the exit ends of orifices as oriented downward, this arrangement in the FIGs. is arbitrary and is not intended to suggest that the delivery path should necessarily be in a downward direction. Generally, the device can be operated in any orientation. In addition, where multiple embodiments are disclosed and described having some features in common, for clarity and ease of illustration, description, and comprehension thereof, similar and like features one to another will ordinarily be described with like reference numerals.

The term “horizontal” as used herein is defined as a plane parallel to the conventional plane or surface of the cover of the current invention, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “processing” as used herein includes deposition of material or photoresist, patterning, exposure, development, etching, cleaning, and/or removal of the material or photoresist as required in forming a described structure. The term “on” means there is direct contact among elements.

There are clinical and analytical chemistry applications that require precise manipulation of small fluid samples within micron to millimeter scale conduits or integrated microfluidic structures. Depending on the overall system requirements, the fluid movement may be driven by a pressure or displacement source, capillary forces, electroosmotic forces, thermocapillary forces, magnetohydrodynamic forces, centrifugal forces, acoustic energy, or electrophoresis. In many of these applications, the pumps, power supplies, valves, motors, and other hardware needed to implement a complete system are much larger and more expensive than the microfluidic component.

Other technologies have been developed in an effort to minimize sample volume and integrate more system functions within a single device. A method and apparatus for dielectrically manipulating droplets immersed in a second dielectric (e.g., water droplets surrounded by a working fluid with a lower dielectric constant) requires employing a plurality of segmented planar electrodes arranged on top and bottom of a fluid housing. Another method and device of employing planar electrodes is to move fluid droplets by establishing a surface tension gradient (i.e., the Marangoni effect) between to adjacent planar electrodes. fluidIn some cases, depending on the properties of the fluid in the droplet and surrounding working fluid, and the characteristics of the electrode arrangement and excitation frequency, the net effect may be an observable change in contact angle at the tri-phase contact line between a solid, the droplet, and the working fluid. This contact angle change is termed “electrowetting.”

The use of electrical forces to move fluids was first reported by Pellat in 1895, who demonstrated non-capillary rising of an essentially non-conductive fluid between two metal plates partially immersed in the fluid, one at ground and the other one at a high voltage. The electrical force density on a piece-wise uniform incompressible linear dielectric fluid, f^{e}, is generated by either the presence of a charge density, ρ, driven by an electric field, Ē; or by the action of the gradient of the scalar Ē·Ē (i.e., the square of the electric field magnitude) on a polarizable material with a dielectric constant ∈ᵣ relative to the permittivity of free space, ∈ₒ. The first term in (1) is the Coulombic force density and the second term is the Kelvin polarization force density (also known as the dielectrophoretic force density on the fluid).

$${f}^{e} = ρ \overline{E} + \frac{1}{2} {ɛ}_{o} ( {ɛ}_{r} - 1 ) ∇ ( \overline{E} \cdot \overline{E} ) \qquad ( 1 )$$

For a fluid with spatially uniform properties, the Kelvin polarization force density can only be generated when the geometry of the electrodes establishes an electric field gradient in the fluid. In a conductive fluid with a low dielectric relaxation time compared to the period of the voltage excitation waveform, internal electric fields and electric field gradients are reduced. In the limit of a perfect conductor, the internal field is null. Thus, as the conductivity of the fluid is increased, internal fields are reduced, and charge accumulates at material interface regions. In such cases, Coulombic forces acting on the surface charge at material interfaces are the primary contributors to the electrical force density.

The fluid actuation provided by the Kelvin polarization force (fluid dielectrophoresis) is another area of interest. In that case, low to moderate conductivity fluids are handled by modulating the electric field such that the period of the applied voltage oscillations is much smaller than the characteristic relaxation time for the system.

Some implementations of fluid dielectrophoresis require the use of an immiscible working fluid surrounding aqueous droplets (e.g., octyl alcohol and silicon oil, respectively) for best results. Partitioning of chemical constituents from the droplets to the surrounding working fluid is a concern for these technologies.

Enzymes are catalyzing proteins that increase the rates of chemical reactions by reducing the initial energy barrier needed to achieve the initial transition state. The activity of enzymes is measured by the reaction velocity in the enzyme-modulated conversion of substrates into products. Enzyme catalytic activity may be modulated by a number of factors in the enzymatic environment.

Enzymes are the targets of approximately 30% of current and experimental drugs. In drug discovery, potential drug candidates are evaluated based on how they inhibit a given target enzyme. Enzyme inhibition/induction measurements are also employed to study drug metabolism and drug interactions in pre-clinical drug development. In particular, in-vitro studies of Cytochrome P450 enzymes yield important pre-clinical data related to drug metabolism and drug-drug interactions.

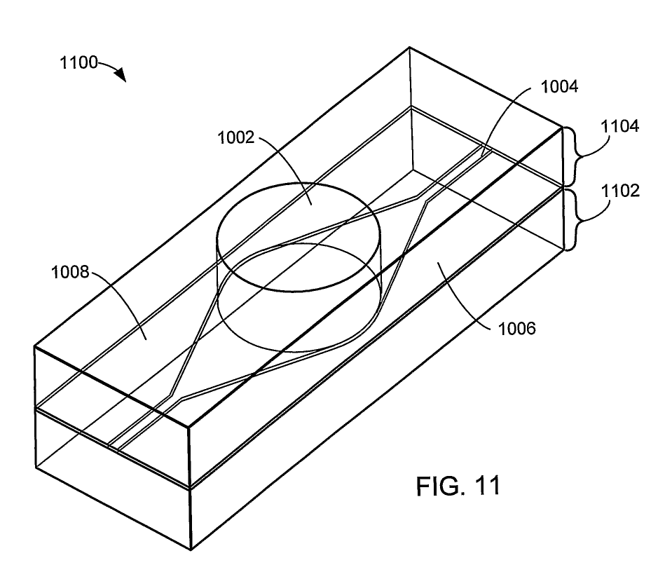

The Michaelis-Menten equation (1) describes how the steady-state reaction velocity, V, varies as a function of substrate concentration, [S]. As seen in FIG. 11, the reaction velocity saturates to a value, Vₘₐₓ, at large substrate concentrations. The Michaelis constant, Kₘ, represents the steady-state substrate concentration at which the reaction velocity reaches half the value of Vₘₐₓ. In addition, the reaction velocity is assumed to increase linearly with the enzyme concentration, [E].

$$V = \frac{{V}_{max} [ S ]}{{K}_{M} + [ S ]} \qquad ( 2 )$$

There are several mechanisms for enzyme inhibition, reversible and irreversible. One common reversible inhibition mode is the direct competition between the substrate and inhibitor. In this case (3), the apparent Michaelis constant increases by the addition of a component equal to Kₘ scaled by the ratio of the inhibitor concentration, [I], to the dissociation constant, Kᵢ.

$$V = \frac{{V}_{max} [ S ]}{[ S ] + {K}_{M} ( 1 + \frac{[ I ]}{{K}_{i}} )} \qquad ( 3 )$$

The effect of the inhibitor is measured by the ratio of the inhibited reaction velocity to the velocity in the absence of an inhibitor, Vₒ. This ratio is usually modeled using a Langmuir isotherm, which relates the decrease in the velocity ratio to the inhibitor concentration [I]. The constant IC₅₀ represents the inhibitor concentration at which the reaction velocity ratio is reduced by 50%.

$$\frac{V}{{V}_{o}} = \frac{1}{1 + \frac{[ I ]}{{IC}_{50}}} \qquad ( 4 )$$

For the case of a competitive inhibition, the inhibitor dissociation constant, Kᵢ, can be calculated using the measured IC₅₀ value, the Michaelis constant for the substrate without inhibitor, K_{M}, and the substrate concentration used for the inhibition experiment, [S].

$${K}_{i} = \frac{{IC}_{50}}{( 1 + \frac{[ S ]}{[ {K}_{M} ]} )} \qquad ( 5 )$$

The reaction velocity response seen in an inhibition experiment for the competitive mechanism is described by equations (4) and (5). In general, it is important to measure both the apparent Michaelis constant K_{M} and the apparent maximum reaction velocity, Vₘₐₓ, for different inhibitor concentrations to determine whether a reversible inhibition mechanism is competitive (i.e., Vₘₐₓ remains constant and the effective K_{M} changes with inhibitor concentration), non-competitive (i.e., both K_{M} and Vₘₐₓ change as a function of [I]), or uncompetitive (where Vₘₐₓ changes with [I] and K_{M} remains constant).

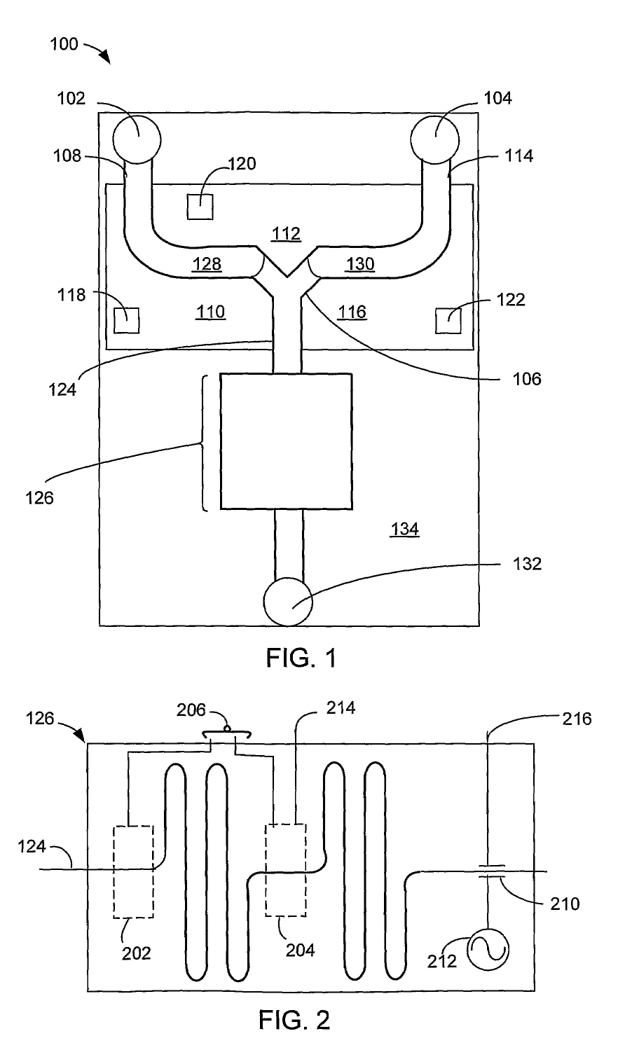

Referring now to FIG. 1, therein is shown an electrically controlled microfluidic system 100, in an embodiment of the present invention. The schematic representation includes a probe fluid inlet 102, a fluid under test inlet 104, a mixing valve 106, attached between the probe fluid inlet 102 and the fluid under test inlet 104. A probe fluid capillary 108 connects the probe fluid inlet 102 to the mixing valve 106. The probe fluid capillary 108 has a first electrode 110 and a second electrode 112 proximate to the path. A fluid under test capillary 114 connects the fluid under test inlet 104 to the mixing valve 106. The second electrode 112 and a third electrode 116 are proximate to the fluid under test capillary 114.

A first electrode contact 118, positioned on the first electrode 110, allows connection to an electrical source (not shown). A second electrode contact 120, positioned on the second electrode, allows connection to a second electrical source (not shown). A third electrode contact 122, positioned on the third electrode 116, allows connection to a third electrical source (not shown). A reaction capillary 124 proceeds from the mixing valve 106 to a reaction analyzer 126. The reaction capillary has the first electrode 110 and the third electrode 116 proximate to the path. The internal surfaces of the probe fluid capillary 108, the fluid under test capillary 114 and the reaction capillary 124 may be marginally hydrophobic or hydrophobic.

A probe fluid 128, which may be converted into a luminescent dye, is injected into the probe fluid inlet 102 is extendable. At the edge of the mixing valve 106, the longitudinal movement of the probe fluid 128 is restricted due to capillary effects. The capillary effect is a combination of the geometrical design and contact angle of the channel walls interacting with the surface tension of the fluid. A fluid under test 130, such as an enzyme and inhibitor solution, is injected in the fluid under test inlet 104 and extends longitudinally to the edge of the mixing valve 106. At the edge of the mixing valve 106, the longitudinal movement of the fluid under test 130 is also restricted due to the capillary effects. When the electrodes are appropriately powered the probe fluid 128 and the fluid under test 130 extends longitudinally into the mixing valve 106.

A luminescent dye includes luminescence, phosphorescence, fluorescence, bioluminescence, chemiluminescence, and other light emitting reactions. Luminescence is the low-temperature emission of light (as by a chemical or physiological process). Phosphorescence is luminescence that is caused by the absorption of radiation at one wavelength followed by delayed reradiation at a different wavelength and that continues for a noticeable time after the incident radiation stops. Fluorescence is luminescence that is caused by the absorption of radiation at one wavelength followed by nearly immediate reradiation usually at a different wavelength and that ceases almost at once when the incident radiation stops. Bioluminescence is the emission of light from living organisms. Chemiluminescence is luminescence (as bioluminescence) due to chemical reaction.

Appropriate electrical sources are attached to the first electrode contact 118, the second electrode contact 120 and the third electrode contact 122. By stimulating the electrodes appropriately, an electric field and electric field gradients are formed around the probe fluid 128 and the fluid under test 130. The electric field acts upon the probe fluid 128 and the fluid under test 130, causing them to move into the mixing valve 106. In the mixing valve 106, the probe fluid 128 and the fluid under test 130 react with each other forming a reacting mixture that moves into the reaction capillary 124 by a combination of capillary effect and electrical forces, provided by both a Coulombic force from a surface charge density at the interface, and a Kelvin polarization force established by the fringing field at the upstream edge of the electrodes.

The reacting mixture proceeds down the reaction capillary 124 and enters the reaction analyzer 126. Within the reaction analyzer 126, optical sensors detect how much light is generated in order to correlate that information to the amount of the reacting mixture entering the reaction analyzer 126. A pair of optical sensors, spaced a known distance apart, generates a differential signal that is used to determine a velocity of reaction for the reacting mixture. The reacting mixture is monitored through multiple means, such as conductivity measuring, optical saturation and radiation monitoring. The reaction capillary 124 extends beyond the reaction analyzer 126 to a waste outlet 132 which is located on a device package 134.

Referring now to FIG. 2, therein is shown a schematic view of the reaction analyzer 126, of FIG. 1. The block diagram depicts the reaction capillary 124 entering the reaction analyzer 126. A first instrument cluster 202 borders the path taken by the reaction capillary 124. The first instrument cluster 202 contains instruments to sense and monitor the reacting mixture as it moves through the reaction analyzer 126. The first instrument cluster 202 may include an optical sensor (not shown), to detect the reaction intensity, a plate capacitor (not shown) with a signal generator (not shown) attached, pH monitors (not shown) to detect conductivity changes in the reacting mixture or radiation sensors to detect signature isotopes present in the reacting mixture.

The reaction capillary 124 continues through the reaction analyzer 126 for a set distance prior to encountering a second instrument cluster 204. The first instrument cluster 202 and the second instrument cluster 204 are linked to share information and learn more about the reacting mixture. A differential signal 206 between the first instrument cluster 202 and the second instrument cluster 204 is a direct indicator of the velocity of reaction of the reacting mixture. A plate capacitor 210 with a signal generator 212 attached acts as a detector of the reaction. The signal generator 212 applying an alternating current to the plate capacitor 210, which may be the first electrode 110 and the third electrode 116 or a separate version of the plate capacitor 210. The measured signal varies in a direct relationship to the position of the reacting mixture as it travels through the reaction capillary 124. The result is an alternating current signal 216 that represents the presence and volume of the reacting mixture in the reaction capillary at that position. An optical signal 214 represents the intensity of the luminescence released by the reacting mixture. The communication of all of the instruments is used to determine the time for the reacting mixture to stop reacting.

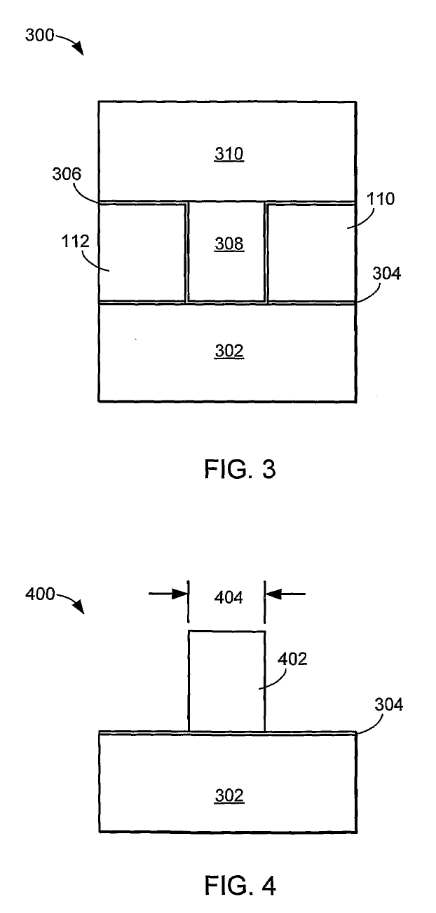

Referring now to FIG. 3, therein is shown a cross-sectional view of the probe fluid capillary 108 of FIG. 1. The probe fluid capillary 108 is typical of the capillary paths. The cross-sectional view depicts a substrate 302, such as a glass layer. The substrate 302 has a metal seed layer 304, such as a tin and copper alloy. The first electrode 110 and the second electrode 112, of a material such as gold, have a dielectric layer 306 that is approximately 0.5 to 2 μm thick. The dielectric layer 306, such as a silicon dioxide, forms an insulation layer between the electrodes and a capillary opening 308. The size of the capillary opening 308 is dependent on the solutions to be tested, in this example with the capillary opening 308 is approximately 30 μm by 40 μm. A glass cover 310 is attached to the top of the dielectric layer 306.

Referring now to FIG. 4, therein is shown a cross-sectional view of the probe fluid capillary 108, of FIG. 1, in a deposition stage of construction. The cross-sectional view depicts the substrate 302 having deposited the metal seed layer 304 and a polyimide structure 402 is patterned on the metal seed layer 304. The patterning process, including masking, deposition, etching and washing, is well known to those skilled in the art and will not be described here. The polyimide structure 402 is etched with a high aspect ratio etch in order to maintain a first critical dimension 404.

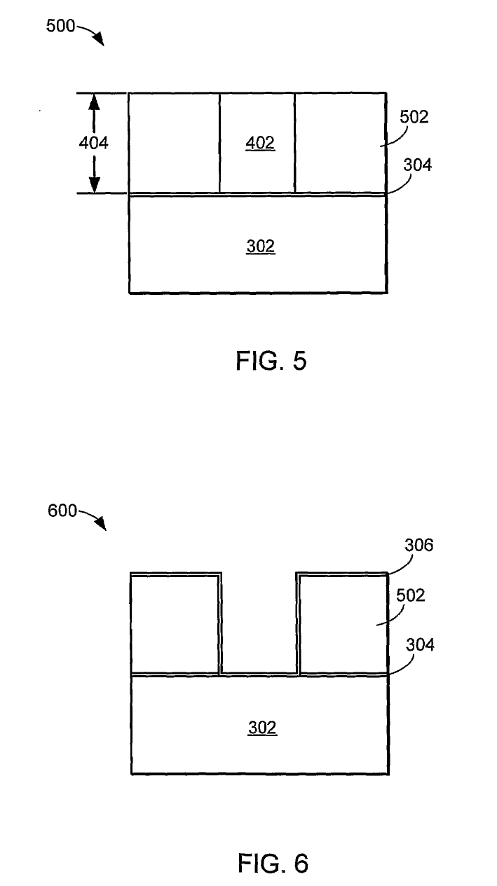

Referring now to FIG. 5, therein is shown a cross-sectional view of the probe fluid capillary 108, of FIG. 1, in a chemical-mechanical planarization phase of manufacturing. The cross-sectional view depicts a conductive layer 502, such as electroplated gold, adhered to the metal seed layer 304. The structure is subjected to a chemical-mechanical planarization, forming a second critical dimension 504.

Referring now to FIG. 6, therein is shown a cross-sectional view of the probe fluid capillary 108, of FIG. 1, in an etching phase of manufacturing. The cross-section view depicts the structure of FIG. 5, having had the polyimide structure 402, of FIG. 4, and a portion of the metal seed layer 304 etched away. The portion of the metal seed layer 304 directly beneath the polyimide structure 402 is etched away, electrically isolating the segments of the conductive layer 502. A conformal deposition of the dielectric layer 306 is applied to the exposed surfaces to act as an electrical insulator. The dielectric layer 306 is deposited by a plasma-enhanced chemical vapor deposition (PECVD).

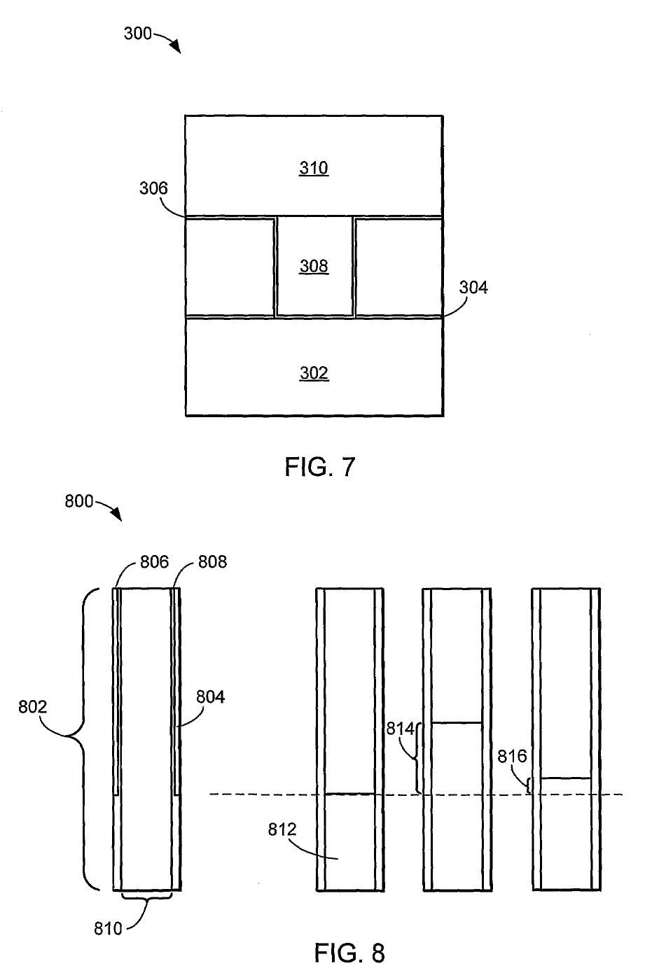

Referring now to FIG. 7, therein is shown a cross-sectional view of the probe fluid capillary 108, of FIG. 1, in an encapsulation phase of manufacturing. The cross-sectional view depicts adding the glass cover 310. The glass cover 310 is pre-drilled to form the probe fluid inlet 102 of FIG. 1, the fluid under test inlet 104 of FIG. 1, the first electrode contact 118 of FIG. 1, the second electrode contact 120 of FIG. 1, the third electrode contact 122 of FIG. 1 and the waste outlet 132 of FIG. 1. The glass cover 310 is bonded to the dielectric layer 306 with an adhesive (not shown), such as a monolayer adhesive.

Referring now to FIG. 8, therein is shown a simulation series of a microfluidic element 800, in an embodiment of the present invention. The simulation series depicts a device structure 802 having a first electrode 804 and a second electrode 806, such as an electroplated gold electrode. The first electrode 804 and the second electrode 806 are adjacent to a thin wall dielectric 808, such as a 2 μm thick dielectric having a dielectric constant ∈ᵣ=3.9. The microfluidic element 800 has a capillary opening 810 of 50 μm.

A fluid 812, such as water, is at rest in the microfluidic element 800 at time equal to 0 sec. The fluid 812 has a conductivity of σ=0.1 mS/m. With the second electrode 806 held at 0 volts, the first electrode 804 is set to 20 volts. At time equal to 1.5 msec, the fluid 812 is elevated within the capillary opening 810 by an additional height 814. Under the same circumstances, having the fluid 812 with a conductivity of σ=100 mS/m results in a smaller change in elevation indicated by a smaller height 816. The difference between the additional height 814 and the smaller height 816 at a given time point indicates a difference in motion control that can be gained by altering the conductivity of the fluid 812.

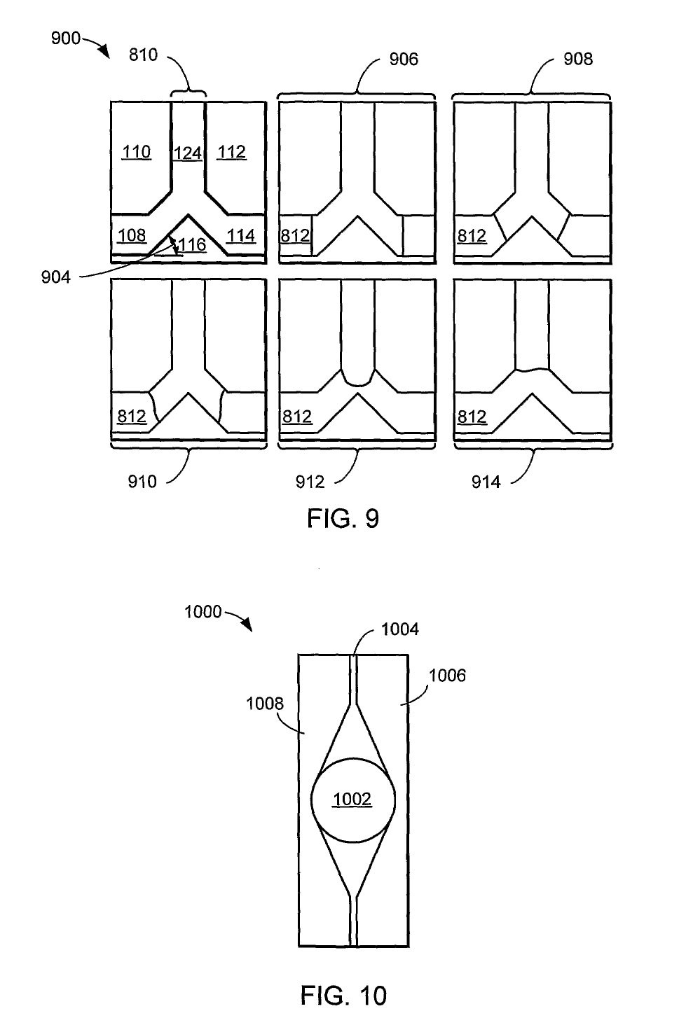

Referring now to FIG. 9, therein is shown a simulation series of a mixing valve element 900, in an embodiment of the present invention. The simulation series depicts a mixer element 902 having the first electrode 110, the second electrode 112 and the third electrode 116. The capillary opening 810 is 30 μm wide. The probe fluid capillary 108 and the fluid under test capillary 114 are designed with an inclination angle 904, of θ=45°, connecting the reaction capillary 124 junction. A first simulation model 906 depicts the initial position of the fluid 812 prior to applying any voltage. A second simulation model 908 shows the equilibrium position reached by the fluid 812 due to the capillary effect when the contact angle at the walls is set to 90°.

Applying a voltage to the first electrode 110, the second electrode 112 and the third electrode 116, establishes an electric field and electric field gradients that can assist or resist the capillary effect in moving the fluid 812. With the first electrode 110 set to 150 volts, the second electrode 112 is set to zero volts and the third electrode 116 set to 75 volts, a third simulation model 910 depicts the position of the fluid 812 after 30 μS has elapsed. A fourth simulation model 912 depicts the position of the fluid 812 after 110 μS has elapsed. A fifth simulation model 914 depicts the position of the fluid 812 after 130 μS has elapsed. In the case of a higher conductivity of the fluid 812 the actuation voltage is significantly reduced, such as V₁=2V₃=10 volts and V₂=0 volts. In this case the voltage V₁ is applied to the first electrode 110, V₂ is applied to the second electrode 112 and V₃ is applied to the third electrode 116.

Referring now to FIG. 10, therein is shown a top view of a bi-directional sample inlet 1000, in an embodiment of the present invention. The bi-directional sample inlet 1000 includes a circular opening 1002 that is approximately 300 μm in diameter. The circular opening 1002 forms a fluid well as it narrows to a capillary section 1004. The circular opening 1002 and the capillary section 1004 are bordered by a first electrode 1006 and a second electrode 1008. The capillary section 1004, the first electrode 1006 and the second electrode 1008 are deposited between glass plates (not shown). The bi-directional sample inlet 1000 delivers the fluid 812 to an upper mixing valve (not shown) and a lower mixing valve (not shown) concurrently.

Referring now to FIG. 11 therein is shown a 3-D solid model of the bi-directional sample inlet 1000, of FIG. 10. The 3-D solid model includes the circular opening 1002, the capillary section 1004, the first electrode 1006 and the second electrode 1008 sandwiched between a lower glass substrate 1102 and a glass cover 1104. The lower glass substrate 1102 and the glass cover 1104 serve as insulators and are inert with the reaction of the fluid 812, of FIG. 8. The lower glass substrate 1102 also allows the use of the first instrument cluster 202, of FIG. 2, to detect the progress of the reaction.

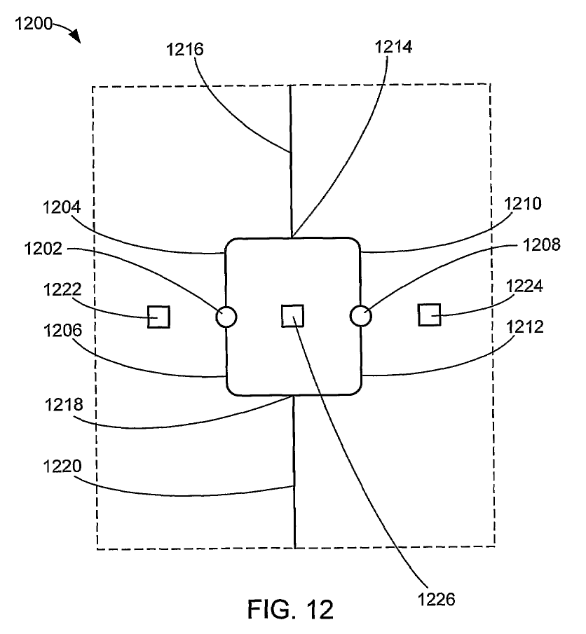

Referring now to FIG. 12, therein is shown a schematic view of the bi-directional sample inlet 1000, in an embodiment of the present invention. The schematic view depicts a probe fluid inlet 1202 connected to an upper probe fluid capillary 1204 and a lower probe fluid capillary 1206. A fluid under test inlet 1208 is connected to an upper fluid under test capillary 1210 and a lower fluid under test capillary 1212. The upper probe fluid capillary 1204 and the upper fluid under test capillary 1210 meet at an upper mixing valve 1214 which connects to an upper reaction capillary 1216.

The lower probe fluid capillary 1206 and the lower fluid under test capillary 1212 meet at a lower mixing valve 1218 which connects to a lower reaction capillary 1220. A first bi-directional electrode contact 1222, a second bi-directional electrode contact 1224 and a third bi-directional electrode contact 1226 allow connection to an external voltage source (not shown). The same voltages are applied to the upper mixing valve 1214 and the lower mixing valve 1218. The bi-directional sample inlet 1000 allows concurrent delivery of the probe fluid and the fluid under test to the upper mixing valve 1214 and the lower mixing valve 1218. The systematic analysis of the fluid under test is enhanced by running tests in parallel.

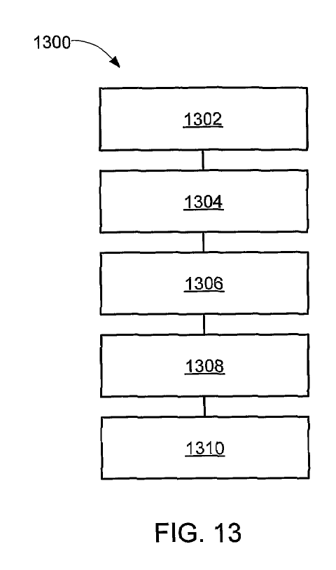

Referring now to FIG. 13, therein is shown a flow chart of an electrically controlled microfluidic system 1300 for electrically controlled microfluidic system in an embodiment of the present invention. The system 1300 includes providing a probe fluid extending longitudinally in a block 1302; restricting a longitudinal movement of the probe fluid by capillary effects in a block 1304; moving the probe fluid longitudinally using an electric field, an electric field gradient, or a combination thereof in a block 1306; reacting a fluid under test with the probe fluid to start a reacting mixture in a block 1308; and measuring the reacting mixture over distance, time, or a combination thereof in a block 1310.

In greater detail, a method to provide an electrically controlled microfluidic system in an embodiment of the present invention, is performed as follows:
1. Providing a substrate; (FIG. 3)
2. Forming a probe fluid capillary for a probe fluid movement, by a combination of capillary and electric forces, on the substrate; (FIG. 1)
3. Forming an electrode proximate the capillary includes attaching a electrode contact to the electrode; (FIG. 1)
4. Applying the electrode with a voltage for moving the probe fluid through the capillary includes multiple electrodes at different voltages; (FIG. 1) and
5. Monitoring a sensor for sensing a velocity of a reaction between the probe fluid and the fluid under test, includes forming a luminescent dye. (FIG. 1)

It has been discovered that the present invention thus has numerous aspects.

It has been discovered that the design principle behind the microfluidic elements employed for the system is to control the velocity and direction of a fluid flow using both capillary and electrical forces. In the absence of electrical forces, the geometry and surface energy of the channels determine the characteristics of the capillary filling process. The exact balance between the use of geometry and surface energy depends on the level of control of these parameters provided by a given manufacturing process. The combination of channel geometry and surface energy thus provides means for controllably stopping the filling process. Electrical forces provide an additional means to control the flow by, for example, offsetting capillary equilibrium. This design approach can be employed to create a variety of microfluidic elements such as mixers, stop valves, selection valves, etc., that can be actuated using simple and inexpensive external components.

The electrically controlled microfluidic system has many aspects compared to fluorescent-based measurements done using a well-plate format and end-point detection. First, the use of a microfluidic environment results in faster, more repeatable, and more precise mixing of the solution samples. Second, in a flow system position represents residence time, and thus reaction velocities can be captured by a single measurement in time. Third, a microfluidic format enables a simplified workflow (e.g., there is no need to add a reagent to stop the solution reaction after incubation) using smaller quantities of reagents. Finally, parallel integration of similar or higher functionality systems can be employed to increase system throughput by running tests in parallel.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the electrically controlled microfluidic system method and apparatus of the present invention furnish important and heretofore unknown and unavailable solutions, capabilities, and functional aspects for fluid reaction testing. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hithertofore set forth herein or shown in the accompanying drawings are to be interpreted in an illustrative and non-limiting sense.

The invention claimed is:

1. An electrically controlled microfluidic system (1300) comprising:
providing a probe fluid (128) extending longitudinally;
restricting a longitudinal movement of the probe fluid (128) by capillary effects;
moving the probe fluid (128) longitudinally using an electric field, an electric field gradient, or a combination thereof;
reacting a fluid under test (130) with the probe fluid (128) to start a reacting mixture; and
measuring the reacting mixture over distance, time, or a combination thereof.

2. The system (1300) as claimed in claim 1 wherein measuring includes using an optical signal (214) indicating the amount of the reacting mixture.

3. The system (1300) as claimed in claim 1 wherein measuring includes using a differential signal (206) over a distance to indicate a velocity of reaction of the reacting mixture.

4. The system (1300) as claimed in claim 1 wherein measuring includes determining the time for the reacting mixture to stop reacting.

5. The system (1300) as claimed in claim 1 wherein measuring includes sensing an alternating current signal (216) when the reacting mixture reaching a predetermined position.

6. An electrically controlled microfluidic system (1300) comprising:
providing a probe fluid (128) extending longitudinally through a probe fluid capillary (108);
restricting a longitudinal movement of the probe fluid (128) by capillary effects in a mixing valve (106);
moving the probe fluid (128) longitudinally using an electric field, an electric field gradient, or a combination thereof;
reacting a fluid under test (130) with the probe fluid (128) to start a reacting mixture extending through the reaction capillary (124); and
measuring the reacting mixture over distance, time, or a combination thereof, using linked instrument clusters (202).

7. The system (1300) as claimed in claim 6 wherein measuring includes using the intensity of an optical signal (214) indicating the amount of the reacting mixture.

8. The system (1300) as claimed in claim 6 wherein measuring includes using a differential signal (206) over a distance to indicate a velocity of reaction of the reacting mixture by timing the transition from a first instrument cluster (202) to a second instrument cluster (204).

9. The system (1300) as claimed in claim 6 wherein measuring includes determining the time for the reacting mixture to stop reacting by monitoring luminescence.

10. The system (1300) as claimed in claim 6 wherein measuring includes sensing an alternating current signal (216) when the reacting mixture reaching a predetermined position by altering the dielectric between the plates of a plate capacitor (210).

11. An electrically controlled microfluidic system (100) comprising:
a substrate (302);
a probe fluid capillary (108) for restricting a longitudinal movement of a probe fluid (128) on the substrate;
an electrode (110) proximate to the probe fluid capillary (108) for moving the probe fluid (128) through the probe fluid capillary (108) using an electric field, an electric field gradient, or a combination thereof; and
an instrument cluster (202) for measuring reaction between the probe fluid (128) and a fluid under test (130) over distance, time, or a combination thereof.

12. The system (100) as claimed in claim 11 further comprising:
a mixing valve (106) to join the probe fluid (128) and the fluid under test (130) for initiating the reaction; and
a reaction capillary (124) of a known length for measuring a time required to traverse the known length.

13. The system (100) as claimed in claim 11 further comprising a dielectric layer (306) deposited on the electrode.

14. The system (100) as claimed in claim 11 further comprising:
a glass cover (310) bonded over the substrate (302); and
inlet (1202) and outlet (132) holes formed in the glass cover (310).

15. The system (100) as claimed in claim 11 further comprising a bi-directional sample inlet (1000) for concurrently delivering the probe fluid (128) to an upper mixing valve (1214) and a lower mixing valve (1218).

16. The system (100) as claimed in claim 11 wherein:
the probe fluid (128) is motivated by a combination of capillary and electric forces;
further comprises:
an electrode contact (118) attached to the electrode (110);
multiple electrodes (110) at different voltages generating an electric field gradient; and
a cluster of instruments (202) for sensing a luminescent dye formed from the reaction between the probe fluid (128) and the fluid under test (130).

17. The system (100) as claimed in claim 16 further comprising:
a mixing valve (106) to join the probe fluid (128) and the fluid under test (130) and start the chemical reaction; and
a reaction capillary (124) of a known length to measure a time required to traverse the known length.

18. The system (100) as claimed in claim 16 further comprising a dielectric layer (306) deposited between the electrode (110) and a capillary opening (308), forms a wall of the capillary (108).

19. The system (100) as claimed in claim 16 further comprising:
a glass cover (310) over the substrate (302) bonded with an adhesive; and
inlet (1202) and outlet (132) holes formed in the glass cover (310) form fluid wells.

20. The system (100) as claimed in claim 16 further comprising a bi-directional sample inlet (1000) delivers the probe fluid (128) to an upper mixing valve (1214) and a lower mixing valve (1218) having the same voltages for a systematic analysis of the fluid under test (130).
